(19) United States
(12) Patent Application Publication
(10) Pub. No.: US 2026/0281563 A1
(43) Pub. Date: Sep. 17, 2026

(54) INFORMATION PROCESSING APPARATUS AND INFORMATION PROCESSING METHOD

(71) Applicant: TOYOTA JIDOSHA KABUSHIKI KAISHA, Toyota-shi (JP)

(72) Inventors: Tatsuya TANIZAWA, Nisshin-shi (JP); Akinori Shin, Toyota-shi (JP); Junichi Todaka, Seto-shi (JP); Kyosuke Nakanishi, Tokyo (JP); Hideo Hasegawa, Nagoya-shi (JP)

(73) Assignee: TOYOTA JIDOSHA KABUSHIKI KAISHA, Toyota-shi (JP)

(21) Appl. No.: 19/432,490

(22) Filed: Dec. 24, 2025

(30) Foreign Application Priority Data
Mar. 13, 2025 (JP) 2025-040530

(51) Int. Cl. H04N 23/74

(52) U.S. Cl. CPC H04N 23/74

(57) ABSTRACT

The present disclosure relates to an information processing apparatus and an information processing method. A controller of the information processing apparatus is configured to execute setting, when detection is made that a camera is capturing an image of a user in a vehicle, a luminance of a display that presents information to the user to a value that is predetermined.

### CROSS-REFERENCE TO RELATED APPLICATION

This application claims priority to Japanese Patent Application No. 2025-040530 filed on Mar. 13, 2025. The disclosure of the above-identified application, including the specification, drawings, and claims, is incorporated by reference herein in its entirety.

### BACKGROUND

### 1. Technical Field

The present disclosure relates to an information processing apparatus and an information processing method.

### 2. Description of Related Art

Japanese Unexamined Patent Application Publication No. 2014-25845 (JP 2014-25845 A) discloses an electric vehicle control device. The electric vehicle control device detects an illuminance outside the electric vehicle. The electric vehicle control device controls a luminance of a driver's console display that can be adjusted in stages to a luminance corresponding to a luminance outside the electric vehicle based on the detected illuminance.

### SUMMARY

An object of the present disclosure is to improve a quality of a video of a user captured in a vehicle.

A first aspect of the present disclosure relates to an information processing apparatus including a controller configured to execute setting, when detection is made that a camera is capturing an image of a user in a vehicle, a luminance of a display that presents information to the user to a predetermined value.

A second aspect of the present disclosure relates to an information processing method executed by a computer, the information processing method including setting, when detection is made that a camera is capturing an image of a user in a vehicle, a luminance of a display that presents information to the user to a predetermined value.

With the present disclosure, a quality of a video of a user captured in a vehicle can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an interior of a vehicle;

FIG. 2 is an enlarged view of a steering wheel;

FIG. 3 is a diagram schematically showing an example of a hardware configuration of the vehicle;

FIG. 4 is a diagram showing a functional configuration of an ECU; and

FIG. 5 is a flowchart of processing executed by the controller.

### DETAILED DESCRIPTION OF EMBODIMENTS

A user may be imaged by a camera in a vehicle. In this case, it is assumed that imaging the user in a case where the interior of the vehicle is dark is difficult as compared to a case where the interior of the vehicle is bright.

Here, a case is assumed in which the display that performs display for the user is provided in the vehicle. In this case, the display performs display for the user by emitting light. Therefore, by increasing the luminance of the display, the amount of light emitted toward the user can be increased. As a result, the amount of light for imaging the user can be ensured.

Therefore, in the information processing apparatus according to the present disclosure, a controller sets, when detection is made that a camera is imaging a user in a vehicle, a luminance of a display that performs display for the user to a predetermined value.

Here, the predetermined value is an amount that is set in advance defined as an amount of light emitted toward the user, suitable for imaging the user with the camera.

As described above, in the information processing apparatus, when the camera images the user in the vehicle, the luminance of the display that performs display for the user is set to the predetermined value. As a result, it is possible to secure an amount of light sufficient for the camera to image the user. As a result, it is possible to improve the quality of the video of the user captured in the vehicle.

Hereinafter, specific embodiments of the present disclosure will be described based on the drawings. Unless otherwise specified, the hardware configuration, module configuration, functional configuration, and the like described in each embodiment are not intended to limit the technical scope of the disclosure.

### EMBODIMENT

An outline of a vehicle system according to the embodiment will be described. The vehicle system according to the present embodiment includes a vehicle 1.

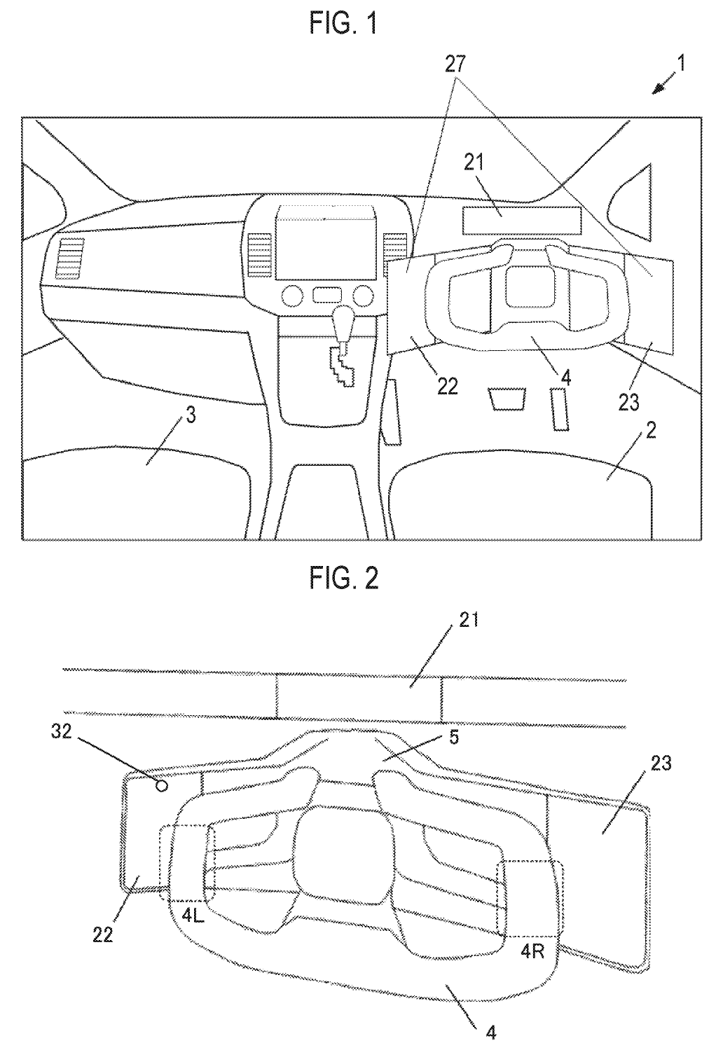

The vehicle 1 will be described with reference to FIG. 1. FIG. 1 is a diagram showing an interior of the vehicle 1. As shown in the drawing, a driver's seat 2 and a passenger seat 3 are provided in a vehicle cabin of the vehicle 1. The vehicle 1 of the present embodiment is a right-hand drive vehicle, and the driver's seat 2 is provided on a right side of the vehicle 1. In addition, the passenger seat 3 is provided on a left side of the driver's seat 2.

A steering wheel 4 is disposed in front of the driver's seat 2. The steering wheel may be circular or may be U-shaped as shown (so-called non-circular steering wheel). The steering wheel 4 is connected to a steering device included in the vehicle 1 via a steering column. The steering column is covered with a column cover.

An instrument cluster display 21 is provided on a vehicle-front side of the steering wheel 4. The instrument cluster display 21 is a full-screen display that is positioned in front of the driver's seat 2 and provides various types of information to the driver of the vehicle 1. For example, information needed for traveling of the vehicle, such as a vehicle speed, an engine rotation speed (when the vehicle 1 includes an engine), a charge and discharge status (when the vehicle 1 includes a drive battery), and a traveling distance, is displayed on the instrument cluster display 21.

A pair of display devices 27 are provided in a front portion of the driver's seat 2 in the vehicle cabin. The display devices 27 include touch panel displays respectively disposed at positions on both lateral sides of the steering wheel 4. In the present embodiment, a display disposed closer to an interior of the vehicle is referred to as an inner display, and a display disposed closer to an outside of the vehicle is referred to as an outer display. The inner display 22 and the outer display 23 are connected to an instrument panel of the vehicle 1.

The detailed structures of the inner display 22 and the outer display 23 will be described with reference to FIG. 2. FIG. 2 is an enlarged view of the steering wheel 4. The inner display 22 and the outer display 23 are vertically long displays, and are connected to a support portion 5 that is a member supporting each display. The support portion 5 has a shape that protrudes in a left-right direction of the steering wheel. The outer display 23 is connected to a right end portion of the support portion 5 toward the vehicle front, and the inner display 22 is connected to a left end portion of the support portion 5 toward the vehicle front. As a result, a display surface can be disposed near a grip portion of the steering wheel 4.

The above description is an example when the vehicle 1 is a right-hand drive vehicle, and when the vehicle 1 is a left-hand drive vehicle, the left and right are reversed. That is, the outer display 23 is connected to a left end portion of the support portion 5 toward the vehicle front, and the inner display 22 is connected to a right end portion of the support portion 5 toward the vehicle front.

The support portion 5 may also serve as the column cover that covers the steering column. The support portion 5 extends in a left-right direction (vehicle width direction) from a portion through which the steering column passes, and each of the support portions extends toward a vehicle rear side and is bent such that an angle with respect to the left-right direction of the steering wheel is reduced in the middle.

In addition, the inner display 22 and the outer display 23 are disposed to have an angle with respect to the left-right direction of the steering wheel and to be inclined toward the steering wheel side, respectively. That is, the inner display 22 is disposed to protrude further toward the vehicle rear as the position is closer to the interior of the vehicle, and the outer display 23 is disposed to protrude further toward the vehicle rear as the position is closer to the outside of the vehicle. Accordingly, the inner display 22 and the outer display 23 are disposed to face the driver, respectively.

In addition, a camera 32 is installed on an upper portion of the inner display 22. Therefore, the camera 32 is disposed to face the driver in accordance with the inner display 22 being disposed to face the driver. That is, the camera 32 is installed to image the driver.

A region 4R shown by a broken line in FIG. 2 is a portion (grip portion) in which the steering wheel 4 is gripped by a right hand of the driver, and a region 4L shown by a broken line in FIG. 2 is a portion (grip portion) in which the steering wheel 4 is gripped by a left hand of the driver. By making the support portion 5 in the above-described shape, the positions of the inner display 22 and the outer display 23 in the vehicle front-rear direction can be brought closer to the grip portion of the steering wheel 4. Therefore, the amount of movement of the hand when the driver performs a touch operation on the inner display 22 or the outer display 23 during driving can be further reduced.

The instrument cluster display 21, the inner display 22, and the outer display 23 are displays each having a touch panel. The touch panel may be provided in at least the inner display 22 and the outer display 23. As the touch panel, for example, a pressure-sensitive type touch panel that detects a pressure applied by the user to the panel, a capacitive type touch panel that detects a change in capacitance when the user presses the panel, or the like can be adopted. The display is, for example, a liquid crystal display (LCD) or an electroluminescence (EL) panel.

The inner display 22 displays, for example, information related to convenience of an occupant of the vehicle 1. The information related to the convenience of the occupant of the vehicle 1 includes information for providing entertainment to the occupant of the vehicle 1. In addition, the information related to the convenience of the occupant of the vehicle 1 includes information (moving image or the like) for providing a video call to the occupant of the vehicle 1. The information related to the convenience of the occupant of the vehicle 1 may include information related to comfort of the occupant, or the like. The information related to the comfort and convenience of the occupant includes, for example, information related to a switch, a button, or the like for operating audio, a navigation device, an air conditioner, a telephone, a clock, a voice assistant, or the like, as well as information related to operating status of these devices.

The outer display 23 displays, for example, information related to the control of the vehicle 1. The information related to the control of the vehicle 1 includes information related to traveling of the vehicle 1. The information related to the control of the vehicle 1 includes, for example, information related to a switch, a button, or the like for operating headlights, wipers, side mirrors, an ADAS, a drive mode, a suspension, a position of a steering wheel, a position of a seat, or the like, as well as information related to operating status of these devices. By causing information related to control of the vehicle 1 to be displayed on the outer display 23, operation of information related to control of the vehicle 1 by passengers other than the driver can be suppressed.

The information displayed on the inner display 22 and the outer display 23 is not limited to the above. The inner display 22 may display the information related to the control of the vehicle 1, or the outer display 23 may display the information related to the convenience of the occupant of the vehicle 1. In addition, the information displayed on the inner display 22 and the outer display 23 can be optionally determined.

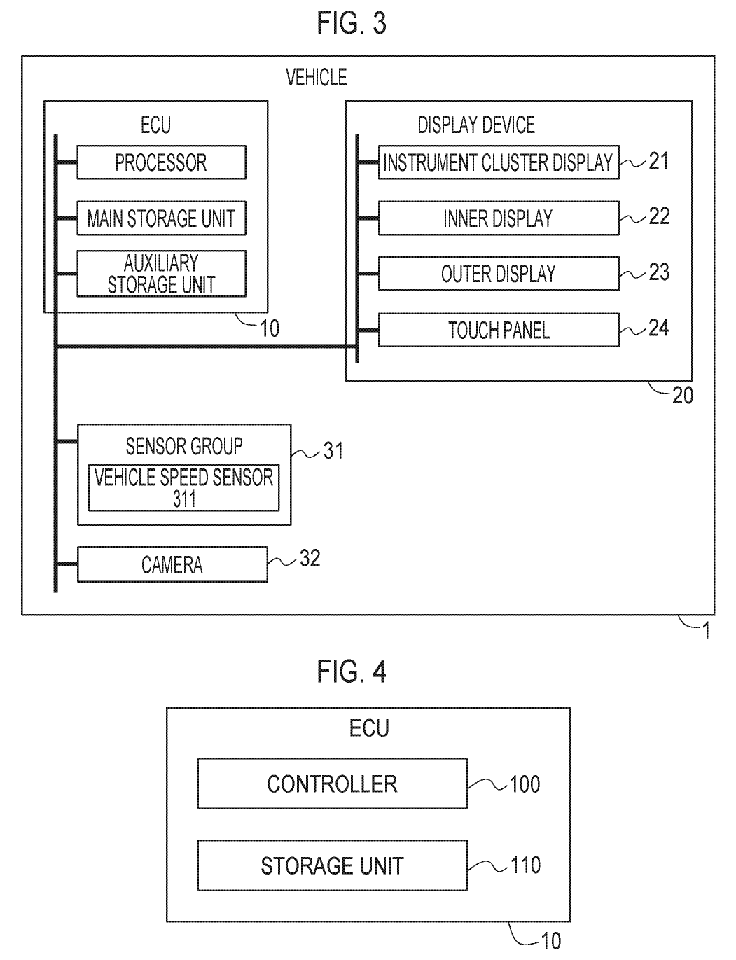

FIG. 3 is a diagram schematically showing an example of a hardware configuration of the vehicle 1. The vehicle 1 includes an ECU 10, a display device 20, a sensor group 31, and the camera 32. The ECU 10 can be configured as a computer including a processor (CPU, GPU, or the like), a main storage device (RAM, ROM, or the like), and an auxiliary storage device (EPROM, hard disk drive, removable medium, or the like). The auxiliary storage device stores an operating system (OS), various programs, various tables, and the like, and by executing the program stored therein, each function (software module) that matches a predetermined purpose as described below can be implemented. However, a part or all of the functions may be implemented as a hardware module by a hardware circuit such as an ASIC or an FPGA. The display device 20, the sensor group 31, and the camera 32 are connected to the ECU 10. The ECU 10 in the present embodiment is an example of an "information processing apparatus" according to the present disclosure.

The display device 20 includes the instrument cluster display 21, the inner display 22, the outer display 23, and a touch panel 24. The touch panel 24 is a unit for detecting a touch operation performed on the instrument cluster display 21, the inner display 22, and the outer display 23. The touch panel 24 is disposed on each of the instrument cluster display 21, the inner display 22, and the outer display 23, and can be operated by touch.

The sensor group 31 is a collection of a plurality of sensors for acquiring sensor data used in traveling of the vehicle 1. The sensor may acquire a physical quantity, image data, or the like. The sensor group 31 includes a vehicle speed sensor 311 that detects a speed of the vehicle 1.

### Functional Configuration

FIG. 4 is a diagram showing a functional configuration of the ECU 10. The ECU 10 includes a controller 100 and a storage unit 110 as functional configuration elements. The controller 100 is, for example, a functional configuration element provided by a processor executing various programs stored in an auxiliary storage unit. The storage unit 110 is means for storing information, and includes a main storage unit and an auxiliary storage unit.

The controller 100 starts a video call application in response to an input operation of the user (driver) via the touch panel 24. Here, the video call application is an application that performs a video call between the user and another user via a network. In the present embodiment, the video call application displays a video of the other user on the inner display 22 and transmits a moving image of the user captured with the camera 32 to communication equipment of the other user. A web conference application may display the video of the other user on a display other than the inner display 22.

The controller 100 determines whether the camera 32 is activated. That is, the controller 100 determines whether the user is imaged with the camera 32. In this case, it is assumed that it is difficult to image the user in a case where the luminance in the vehicle 1 is low as compared to a case where the luminance in the vehicle 1 is high. However, the display device 20 performs display for the user by emitting light. Therefore, by increasing the luminance of the display device 20, the amount of light emitted toward the user can be increased.

Therefore, when determination is made that the camera 32 is activated, the controller 100 sets the luminance of the inner display 22 to the predetermined value. Here, the predetermined value is an amount that is set in advance defined as an amount of light emitted from the inner display 22 toward the user, suitable for imaging the user with the camera 32.

Here, when the luminance of the inner display 22 is set to the predetermined value, thereby increasing the luminance, the amount of light emitted toward the user driving vehicle 1 increases, potentially interfering with driving by the user. Therefore, by limiting the setting of the luminance of the inner display 22 to the predetermined value to when the vehicle 1 is stopped, an increase in the amount of light emitted from the inner display 22 toward the user driving the vehicle 1 during traveling can be suppressed.

Therefore, the controller 100 acquires the speed of the vehicle 1 from the vehicle speed sensor 311. When the speed of the vehicle 1 acquired from the vehicle speed sensor 311 is greater than 0, the controller 100 omits the setting the luminance of the inner display 22 to the predetermined value. That is, when the vehicle 1 is not stopped, the controller 100 omits the setting the luminance of the inner display 22 to the predetermined value.

In addition, the controller 100 may determine whether the vehicle 1 is stopped by a method other than determining whether the speed of the vehicle 1 is greater than 0. For example, the controller 100 may determine that the vehicle 1 is stopped when a shift lever of the vehicle 1 is in a parking position. In addition, the controller 100 may determine that the vehicle 1 is stopped when the vehicle 1 is in an accessory mode. That is, the controller 100 may determine that the vehicle 1 is stopped in a state of being completely stopped.

In addition, the current luminance of the inner display 22 may be greater than the predetermined value. In this case, when the luminance of the inner display 22 is set to the predetermined value, the amount of light emitted toward the user is reduced. Therefore, when the current luminance of the inner display 22 is greater than the predetermined value, the controller 100 omits the setting the luminance of the inner display 22 to the predetermined value.

The controller 100 determines whether the camera 32 has ended the imaging. The controller 100 determines whether the camera 32 has ended the imaging, for example, in accordance with whether the video call has ended in the video call application. When determination is made that the camera 32 has ended the imaging, the controller 100 sets the luminance of the inner display 22 to the luminance before the setting to the predetermined value. That is, when the camera 32 has ended the imaging, the luminance of the inner display 22 is restored to the state before the setting.

In addition, when the vehicle 1 starts traveling after the luminance of the inner display 22 is set to the predetermined value, the controller 100 restores the luminance of the inner display 22 to the state before the setting. That is, when the speed of the vehicle 1 acquired from the vehicle speed sensor 311 is greater than 0, the controller 100 restores the luminance of the inner display 22 to the state before the setting.

### Flowchart

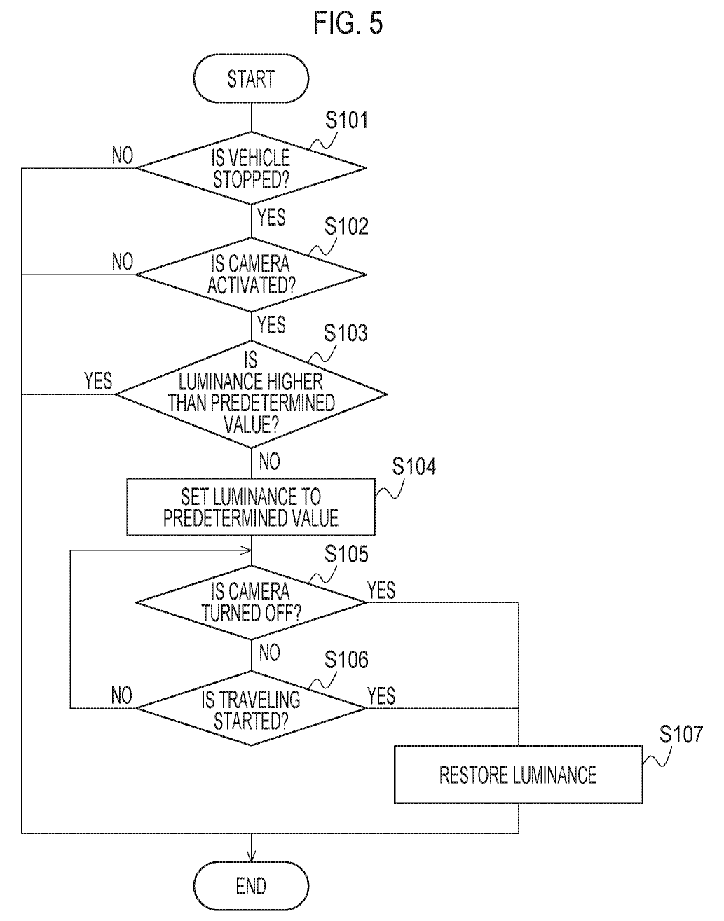

Next, processing executed by the controller 100 will be described based on FIG. 5. FIG. 5 is a flowchart of processing executed by the controller 100. The processing is processing for setting the luminance of the inner display 22 to the predetermined value when the camera images the user. The processing is repeatedly executed at predetermined intervals when the video call application is activated.

In the processing shown in FIG. 5, first, in S101, determination is made whether the vehicle 1 is stopped. When a negative determination is made in S101, the vehicle 1 is traveling. Therefore, in order to suppress an increase in the amount of light emitted from the inner display 22 toward the user driving the vehicle, the processing shown in FIG. 5 is ended.

When a positive determination is made in S101, determination is made in S102 whether the camera 32 is activated. When a negative determination is made in S102, the camera 32 is not activated, and thus there is no need to increase the luminance of the inner display 22. Therefore, the processing shown in FIG. 5 is ended.

Here, a negative determination in S102 is made, for example, in a situation in which a video call application is activated but the user is not conducting a video call. In addition, the negative determination in S102 is made, for example, in a situation in which the video call application is activated but the video of the user is not transmitted to the other user. In this case, the user conducts the call by transmitting the audio data to the other user.

When a positive determination is made in S102, determination is made in S103 whether the current luminance is higher than the predetermined value. When a positive determination is made in S103, since an amount of light sufficient for imaging the user is ensured, setting the luminance of the inner display 22 to the predetermined value is not needed. Therefore, the processing shown in FIG. 5 is ended.

When a negative determination is made in S103, the luminance of the inner display 22 is set to the predetermined value in S104. That is, when a negative determination is made in S103, the luminance of the inner display 22 is increased from the current luminance to the predetermined value. Next, in S105, determination is made whether the camera 32 has ended the imaging. When a positive determination is made in S105, since the imaging of the user is ended, the luminance of the inner display 22 is restored to the original luminance in S107. Then, the processing shown in FIG. 5 is ended. Here, the positive determination is made in S105 when the video call application is ended or the video call application is activated but the transmission of the video of the user to the other user is stopped.

When a negative determination is made in S105, determination is made in S106 whether the vehicle 1 has started traveling. When a negative determination is made in S106, the processing of S105 is executed again. That is, the processing of S105 and S106 is repeatedly executed until the camera 32 stops the imaging or the vehicle 1 starts traveling. When a positive determination is made in S106, the luminance of the inner display 22 is restored to the state before the setting in S107. Then, the processing shown in FIG. 5 is ended.

As described above, in the vehicle system, when the camera 32 images the user in the vehicle 1, the luminance of the inner display 22 is set to the predetermined value. As a result, an amount of light sufficient for the camera 32 to image the user can be ensured. In addition, the camera 32 is mounted on the inner display 22. Therefore, the camera 32 is also disposed to face the driver together with the inner display 22. Therefore, the camera 32 can image the user illuminated by the inner display 22. As a result, the quality of the video of the user captured in the vehicle 1 can be improved.

### Modification 1

In the present embodiment, the luminance of the inner display 22 is set to the predetermined value. However, the luminance of a display other than the inner display 22 may also be set to the predetermined value. For example, the luminance of the instrument cluster display 21 and the outer display 23 may also be set to the predetermined value. In addition, the luminance of any display that displays information to the user, other than the instrument cluster display 21, the inner display 22, and the outer display 23, may be set to the predetermined value. In addition, different predetermined values may be set for each display. Even in this case, the amount of light emitted toward the user can be increased, and the quality of the video of the user captured in the vehicle 1 can be improved.

### Modification 2

In the present embodiment, the camera 32 is mounted on the inner display 22. However, the camera 32 needs not be mounted on the inner display 22. The camera 32 may be attached to, for example, the instrument cluster display 21 or the outer display 23. In this case, the video call application may display the video of the other user on the instrument cluster display 21 or the outer display 23.

In addition, when the vehicle 1 is in a stopped state, safety can be ensured without checking the display of the instrument cluster display 21. Therefore, when the vehicle 1 is in a stopped state, the video of the other user may be displayed on the instrument cluster display 21. In this case, the video of the other user may be displayed on a part or all of the instrument cluster display 21.

In addition, the camera 32 may be attached to any position in the vehicle 1 other than the instrument cluster display 21, the inner display 22, or the outer display 23.

### Modification 3

The ECU 10 may determine whether to set the luminance of the inner display 22 to the predetermined value in accordance with the luminance in the vehicle 1. The ECU 10 may determine to set the luminance of the inner display 22 to the predetermined value when the luminance in the vehicle 1 detected by the luminance sensor included in the sensor group 31 is less than a threshold value. In this case, the ECU 10 sets the luminance of the inner display 22 to the predetermined value when the luminance in the vehicle 1 detected by the luminance sensor included in the sensor group 31 exceeds the threshold value. In addition, the ECU 10 may determine to set the luminance of the inner display 22 to the predetermined value when the luminance of the captured image of the user with the camera 32 is less than the threshold value. In this case, the ECU 10 omits setting the luminance of the inner display 22 to the predetermined value when the luminance of the captured image exceeds the threshold value. Here, the ECU 10 may determine to set the luminance of the inner display 22 to the predetermined value when the luminance in the vehicle 1 matches the threshold value or the luminance of the captured image matches the threshold value.

### OTHER EMBODIMENTS

The embodiment described above is merely an example, and the present disclosure may be implemented with appropriate modifications without departing from the gist thereof. In addition, the processing and means described in the present disclosure can be implemented in any combination as long as no technical inconsistencies arise.

In addition, the processing described as being performed by one device may be executed by a plurality of devices in a shared manner. Alternatively, the processing described as being performed by different devices may be executed by one device. In a computer system, a hardware configuration (server configuration) for realizing each function can be flexibly changed.

The present disclosure can also be realized by supplying a computer program in which the functions described in the above embodiment are implemented to a computer, and reading and executing the program by one or more processors possessed by the computer. Such a computer program may be provided to the computer by a non-transitory computer-readable storage medium that can be connected to the computer's system bus, or may be provided to the computer via a network. The non-transitory computer-readable storage medium includes, for example, any type of disk such as a magnetic disk (floppy (registered trademark) disk or a hard disk drive (HDD)), an optical disk (CD-ROM, a DVD disk, a blue-ray disk, or the like), any type of medium suitable for storing electronic commands, such as a read-only memory (ROM), a random access memory (RAM), an EPROM, an EEPROM, a magnetic card, a flash memory, or an optical card.

What is claimed is:

1. An information processing apparatus comprising a controller configured to execute setting, when detection is made that a camera is capturing an image of a user in a vehicle, a luminance of a display that presents information to the user to a predetermined value.

2. The information processing apparatus according to claim 1, wherein the controller is configured to further execute determining whether the vehicle is stopped, and omitting the setting of the luminance of the display to the predetermined value when the vehicle is not stopped.

3. The information processing apparatus according to claim 1, wherein the controller is configured to further execute acquiring a current luminance of the display, and omitting the setting of the luminance of the display to the predetermined value when the current luminance is higher than the predetermined value.

4. The information processing apparatus according to claim 1, wherein the camera is mounted on the display.

5. An information processing method executed by a computer, the information processing method comprising setting, when detection is made that a camera is capturing an image of a user in a vehicle, a luminance of a display that presents information to the user to a predetermined value.
